(19) United States
(12) Patent Application Publication
(10) Pub. No.: US 2026/0083154 A1
(43) Pub. Date: Mar. 26, 2026

(54) AQUATIC PROTEIN PRETREATMENT METHOD

(71) Applicant: Guangdong Ocean University, Guangdong (CN)

(72) Inventors: Shucheng LIU, Guangdong (CN); Qinxiu SUN, Guangdong (CN); Zefu WANG, Guangdong (CN); Qiumei LIU, Guangdong (CN); Shuai WEI, Guangdong (CN); Yang LIU, Guangdong (CN); Zongyuan HAN, Guangdong (CN); Di ZHANG, Guangdong (CN); Qiuyu XIA, Guangdong (CN); Hongwu JI, Guangdong (CN)

(73) Assignee: Guangdong Ocean University, Guangdong (CN)

(21) Appl. No.: 19/111,791

(22) PCT Filed: Feb. 20, 2023
(86) PCT No.: PCT/CN2023/077245

§ 371 Date: Mar. 14, 2025

(30) Foreign Application Priority Data
Sep. 20, 2022 (CN) 202211144525.3

(51) Int. Cl. A23J 3/04; A23J 3/34

(52) U.S. Cl. CPC A23J 3/04; A23J 3/341

(57) ABSTRACT

The present invention relates to the field of efficient utilization of biological resources and discloses an aquatic protein pretreatment method. According to the method, an aquatic protein is pretreated by using a dense phase carbon dioxide (DPCD) technology, and conditions of the DPCD technology are that: a pressure is 5-30 MPa, a temperature is 30-60° C., and a time is 10-60 min. According to the present invention, by using the DPCD technology to pretreat the aquatic protein and specifically controlling the conditions (pressure, temperature, and time) of the technology, not only is the degree of hydrolysis of the aquatic protein treated by means of the DPCD technology remarkably increased, but also the flavor (taste and smell) of an enzymatic hydrolysate of the aquatic product is remarkably improved, and a utilization rate of protein resources is remarkably increased.

### TECHNICAL FIELD

The present invention belongs to the technical field of efficient utilization of biological resources. More specifically, the present invention relates to an aquatic protein pretreatment method.

### RELATED ART

At present, aquatic proteins are usually subjected to enzymolysis by using a biological enzymolysis method in the market to develop and obtain bioactive peptides, condiments and other products. However, the aquatic proteins have a relatively low degree of hydrolysis after direct enzymolysis, and enzymatic hydrolysates also have a relatively poor flavor. Therefore, in order to solve the problems, the aquatic proteins are usually pretreated in practical production to appropriate change structures of the proteins, promote stretching of peptide chains of the proteins and expose more enzyme cutting sites, thereby increasing the degree of hydrolysis of the aquatic proteins and improving the flavor of the enzymatic hydrolysates. However, not all pretreatment methods can achieve the effects. For example, according to heating pretreatment, excessive denaturation and aggregation of the proteins are likely to be caused, and the enzyme cutting sites are hidden and are not prone to contact with protease. By means of the pretreatment method, the degree of hydrolysis of the proteins is decreased. Therefore, it is quite necessary to find a pretreatment method capable of appropriately changing a protein to increase the degree of hydrolysis of the aquatic proteins and improve the flavor of the enzymatic hydrolysates.

A dense phase carbon dioxide (DPCD) technology is a novel and green non-thermal processing technology. According to the technology, materials are treated with CO₂ at a pressure of less than 50 MPa and a temperature of lower than 60° C. As proposed by Zhou Xuefu et al., structures of proteins can be changed by using the DPCD technology (Zhou Xuefu, et al. “Research progress on effects of dense phase carbon dioxide on structures of proteins in food and processing characteristics.” Dairy Science and Technology 43.01 (2020): 39-44. doi: 10.15922/j.cnki.jdst.2020.01.008.). However, changing the structures of the proteins can neither necessarily increase the degree of hydrolysis of the proteins, nor improve the flavor of enzymatic hydrolysates of the proteins. At present, relevant documents about effects of the DPCD technology on the degree of hydrolysis of the proteins and the flavor of the enzymatic hydrolysates of the proteins have not been found yet.

### SUMMARY OF INVENTION

Aiming at the disadvantages of the prior art, the present invention provides an aquatic protein pretreatment method. An aquatic protein is pretreated by using a dense phase carbon dioxide technology to increase the degree of hydrolysis of the protein and improve the flavor of an enzymatic hydrolysate of the protein.

A first purpose of the present invention is to provide an aquatic protein pretreatment method.

A second purpose of the present invention is to provide a method for increasing the degree of hydrolysis of an aquatic protein.

A third purpose of the present invention is to provide a method for improving the flavor of an enzymatic hydrolysate of an aquatic protein.

The above purposes of the present invention are achieved through the following technical solutions.

The present invention provides an aquatic protein pretreatment method. According to the method, an aquatic protein is pretreated by using a dense phase carbon dioxide (DPCD) technology, and conditions of the DPCD technology are that: a pressure is 5-30 MPa, a temperature is 30-60° C., and a time is 10-60 min.

According to the present invention, by using the DPCD technology to pretreat the aquatic protein and specifically controlling the conditions (pressure, temperature, and time) of the technology, not only is the degree of hydrolysis of the aquatic protein treated by means of the DPCD technology remarkably increased, but also the flavor (taste and smell) of an enzymatic hydrolysate of the aquatic product is remarkably improved, anda utilization rate of protein resources is remarkably increased.

Preferably, the pressure is 15-30 MPa, most preferably 20 MPa.

Preferably, the temperature is 40-60° C., most preferably 50° C.

Preferably, the time is 20-60 min, most preferably 30 min.

According to the method, not only is the degree of hydrolysis of the aquatic protein treated by means of the DPCD technology remarkably increased, but also the flavor (taste and smell) of an enzymatic hydrolysate of the aquatic product is remarkably improved, and a utilization rate of protein resources is remarkably increased. Therefore, the present invention further provides a method for increasing the degree of hydrolysis of an aquatic protein and a method for improving the flavor of an enzymatic hydrolysate of an aquatic protein, specifically including pretreating the aquatic protein by using the above method.

Preferably, the aquatic protein includes one or several of a fish protein, a shrimp protein, and a shellfish protein.

The present invention has the following beneficial effects.

According to the present invention, by using the DPCD technology to pretreat the aquatic protein and specifically controlling the conditions (pressure, temperature, and time) of the technology, not only is the degree of hydrolysis of the aquatic protein treated by means of the DPCD technology remarkably increased (up to 39.48%), but also the flavor (taste and smell) of an enzymatic hydrolysate of the aquatic product is remarkably improved, and an utilization rate of protein resources is remarkably increased.

### BRIEF DESCRIPTION OF DRAWINGS

FIG. 1A shows determination results of the degree of hydrolysis of proteins at different pressures of DPCD, FIG. 1B shows determination results of the degree of hydrolysis of proteins at different time points of DPCD, and FIG. 1C shows determination results of the degree of hydrolysis of proteins at different temperatures of DPCD.

FIG. 2 shows determination results of the degree of hydrolysis of proteins in a heat treatment group.

FIG. 3A shows determination results of the taste of enzymatic hydrolysates of proteins at different pressures of DPCD, FIG. 3B shows determination results of the taste of enzymatic hydrolysates of proteins at different time points of DPCD, and FIG. 3C shows determination results of the taste of enzymatic hydrolysates of proteins at different temperatures of DPCD.

FIG. 4A shows determination results of the smell of enzymatic hydrolysates of proteins at different pressures of DPCD, FIG. 4B shows determination results of the smell of enzymatic hydrolysates of proteins at different time points of DPCD, and FIG. 4C shows determination results of the smell of enzymatic hydrolysates of proteins at different temperatures of DPCD.

### DESCRIPTION OF EMBODIMENTS

The present invention is further illustrated below in combination with drawings attached to the specification and specific examples, but the examples are not intended to limit the present invention in any manner. Unless otherwise specified, reagents, methods and equipment used in the present invention are conventional reagents, methods and equipment in the technical field.

Unless otherwise specified, all reagents and materials used in the following examples are commercially available.

### Embodiment 1 Aquatic Protein Pretreatment Method

### I. Test Materials

Fresh Litopenaeus vannamei heads were stored in a refrigerator at −18° C. for later use.

### II. Reagents and Instruments

Main experimental reagents are shown in Table 1, and main instruments and equipment are shown in Table 2.

TABLE 1
Main experimental reagents

| Reagent name | Manufacturer |
|---|---|
| Coomassie brilliant blue | Beijing Solarbio |
| protein assay kit | Science&Technology Co., Ltd. |
| Coomassie brilliant blue | Shanghai Beyotime |
| staining solution | Biotechnology Co., Ltd. |
| Protein loading buffer (5×) | Shanghai Beyotime |
| | Biotechnology Co., Ltd. |
| Phosphate buffer | Shanghai Beyotime |
| (10 × PBS, pH 7.4) | Biotechnology Co., Ltd. |
| Papain (200,000 u/g) | Nanning Pangbo |
| | Biopharmaceutical Co., Ltd. |
| Methyl nonanoate | Sinopharm Reagent Co., Ltd. |
| (chromatographic grade) | |
| Methanol (chromatographic | Sinopharm Reagent Co., Ltd. |
| grade) | |
| Formaldehyde | Xilong Scientific Co., Ltd. |
| (37.0-40.0%) | |

TABLE 2
Main instruments and equipment

| Instrument and equipment name | Manufacturer |
|---|---|
| JYL-C022 meat mincer | Shandong Joyoung Co., Ltd. |
| DPCD treatment device | Nantong Huaan Supercritical |
| | Extraction Co., Ltd. |
| Sigma3-30KS desktop | Germany sigma Centrifuge |
| high-speed | Co., Ltd. |
| freezing centrifuge | |
| VOPADEST 450 full-automatic | China Guangzhou Gerhardt |
| kjeldahl apparatus | Instrument Co., Ltd. |
| SHY-2 digital display water | Changzhou Putian Instrument |
| bath thermostatic shaker | Manufacturing Co., Ltd. |
| PB-10 pH meter | Germany Sartorius |
| PEN3 electronic nose | Germany Airsense |
| INSENTTS-5000Z | Beijing Ensoul Technology |
| electronic tongue | Co., Ltd. |
| CR-20 colorimeter | Japan minolta Inc. |
| Varioskan Flash | America Thermo Fisher |
| full-automatic | Scientific Inc. |
| microplate reader | |
| BJPX-150 thermostatic | Shandong Biobase Scientific |
| incubator | Instrument Co., Ltd. |
| DK-98- II water | Tianjin Taisite Instrument |
| bath pot | Co. Ltd. |

### III. Data Processing

Each experiment was repeated for 3 times, and correlation analysis and drawing were performed by using Origin software.

### IV. Experimental Method

### 1. Pretreatment

The frozen shrimp heads were thawed in a refrigerator at 4° C. in advance and then minced with a meat mincer. 10 g of the minced shrimp heads were weighed in multiple parts and uniformly mixed with distilled water added at a mass ratio of 1:1 to obtain shrimp head pulps for later use, which were divided into DPCD treatment groups, a heat treatment group and an untreated group.

### (1) DPCD Treatment Groups

At the beginning of a test, a main switch, a refrigeration unit and a cooling circulation system of a DPCD treatment device were turned on first, the cooling circulation system was lowered to 4° C., and after the temperature of a treatment kettle was raised to a set temperature, the shrimp head pulps were placed into the treatment kettle. The treatment kettle was sealed, a CO₂ charging valve was switched on, an exhaust valve was switched on simultaneously for 15 s to discharge air in the treatment kettle, a pressure relief valve was switched off, and a high pressure pump was turned on to pump CO₂ into the treatment kettle. When the pressure was raised to a required pressure, the high pressure pump was turned off, and the charging valve of the treatment kettle was switched off to maintain the required pressure and temperature in the treatment kettle. After static treatment for a period of time, the exhaust valve of the treatment kettle was switched on to relieve pressure, samples were taken out to complete DPCD treatment, and the samples were cooled to 25° C. after the treatment was completed.

Wherein, conditions of the DPCD treatment were as follows:

DPCD treatment group at different pressures: the temperature was fixed at 50° C. the time was fixed at 30 min, and the pressure was set at 5, 10, 15, 20, 25, and 30 MPa, respectively.

DPCD treatment group at different temperatures: the pressure was fixed at 20 MPa, the time was fixed at 30 min, and the temperature was set at 30, 40, 50, and 60° C. respectively.

DPCD treatment group at different time points: the pressure was fixed at 20 MPa, the temperature was fixed at 50° C., and the time was set at 10, 20, 30, 40, 50, and 60 min, respectively.

### (2) Heat Treatment Group

The shrimp head pulps were heated for pretreatment at 50, 60, 70, 80, 90, and 100° C., respectively, the treatment time was set at 5, 10, 15, 20, and 30 min under each temperature condition, and the shrimp head pulps were cooled to 25° C. after the treatment was completed.

(3) Untreated group: The shrimp head pulps without any treatment were placed in an environment at 25° C.

### 2. Enzymolysis

The shrimp head pulps in the DPCD treatment groups, the heat treatment group and the untreated group were added into papain that was 0.5% of the mass of the shrimp heads at a pH of 7 and a temperature of 55° C., respectively, stirred for enzymolysis in a thermostatic water bath at 55° C. for 4 h, and then heated for enzyme deactivation in a boiling water bath for 10 min, followed by centrifugation at 10,000 rpm for 20 min. Supernatants obtained after the centrifugation were enzymatic hydrolysates.

### Embodiment 2 Analysis of the Degree of Hydrolysis of Aquatic Proteins after DPCD Treatment

### I. Determination of the Degree of Hydrolysis of Proteins

The content of amino acid nitrogen in the shrimp head pulps in each group before and after enzymolysis was determined by referring to a method in GB5009.235-2016. After the content of total nitrogen in the shrimp head pulps in each group before treatment was determined by referring to a method in GB5009.5-2016, the shrimp head pulps in each group were treated with trichloroacetic acid until a precipitate was produced, the content of protein nitrogen in the precipitate was determined referring to GB5009.5-2016, and the content of non-protein nitrogen was obtained by subtracting the content of protein nitrogen from the content of total nitrogen.

A percentage of a peptide bond cleaved in a raw protein is used to express the degree of hydrolysis of the protein catalyzed by an enzyme, that is, a DH value, and a calculation formula is as follows:

$$degree of hydrolysis DH ( \% ) = \frac{C - D}{A - B} \times 100$$

in the formula: A: content of total nitrogen in the raw material, g/100 g: B: content of non-protein nitrogen in the raw material, g/100 g: C: content of amino acid nitrogen after enzymolysis, g/100 g: D: content of amino acid nitrogen before enzymolysis, g/100 g.

### II. Determination Results

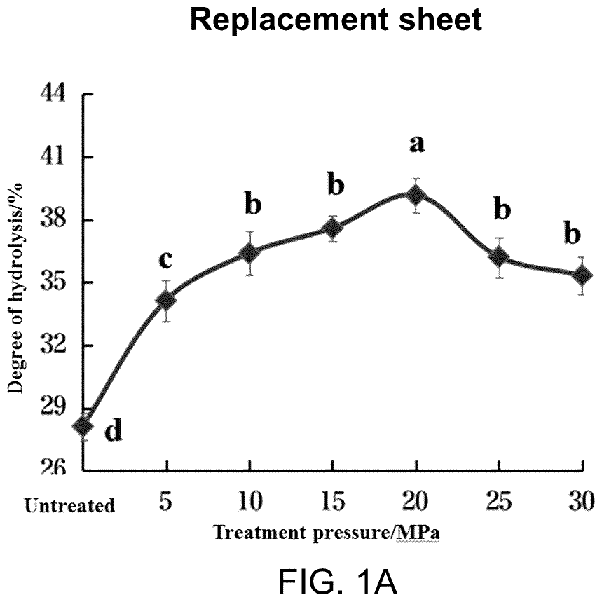

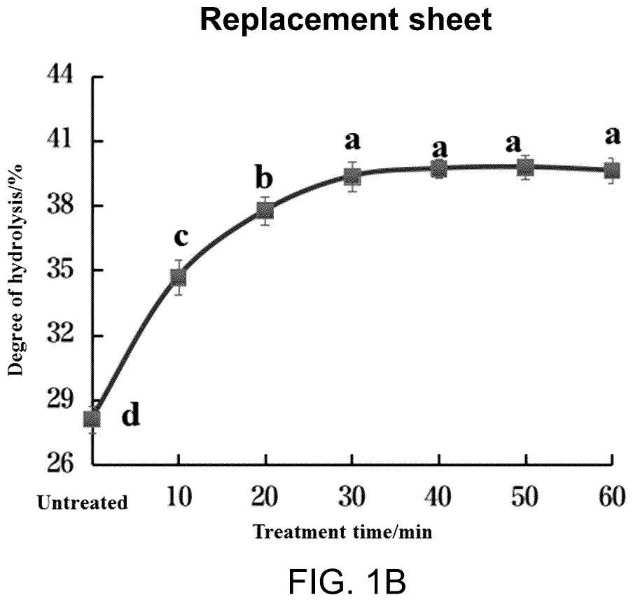

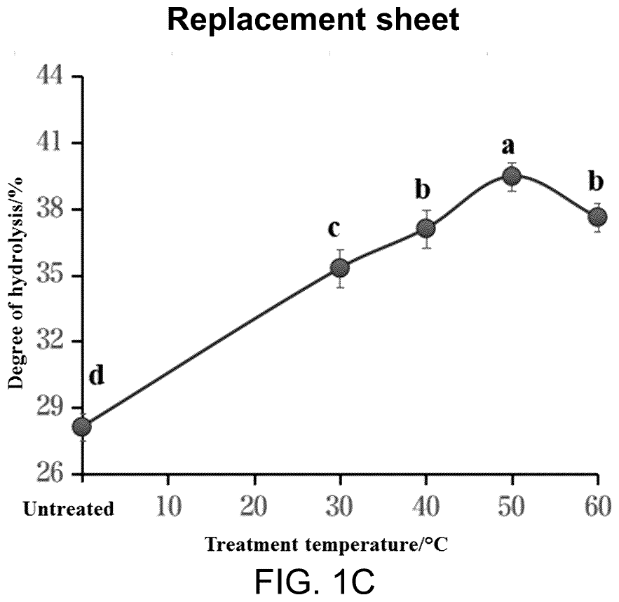

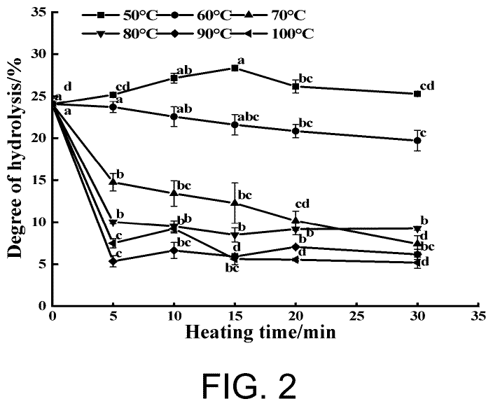

Determination results of the degree of hydrolysis of proteins in the DPCD treatment groups, the heat treatment group and the untreated group are shown in FIG. 1 and FIG. 2, wherein FIG. 1A shows determination results of the degree of hydrolysis of proteins at different pressures of DPCD, FIG. 1B shows determination results of the degree of hydrolysis of proteins at different time points of DPCD, FIG. 1C shows determination results of the degree of hydrolysis of proteins at different temperatures of DPCD, and FIG. 2 shows determination results of the degree of hydrolysis of proteins in the heat treatment group.

As can be seen from FIG. 1A, at the fixed treatment time of 30 min and the temperature of 50° C., when the pressure is 20 MPa, the degree of hydrolysis of the shrimp head protein reaches the maximum (i.e., 39.15%), which is increased by 11.03% compared with the untreated group. As can be seen from FIG. 1B, at the fixed treatment pressure of 20 MPa and the temperature of 50° C., when the treatment time is 30 min, the degree of hydrolysis of the shrimp head protein reaches the maximum (i.e., 39.36%), which is increased by 11.24% compared with the untreated group. As can be seen from FIG. 1C, at the fixed treatment pressure of 20 MPa and the time of 30 min, when the treatment temperature is 50° C., the degree of hydrolysis of the shrimp head protein reaches the maximum (i.e., 39.48%), which is increased by 11.36% compared with the untreated group. It can be seen that the degree of hydrolysis of the shrimp head protein is remarkably increased after the DPCD treatment.

As can be seen from FIG. 2, with increase of the heating treatment temperature and prolonging of the time, the degree of hydrolysis of the shrimp head protein shows a decreasing trend. It can be seen that a heating pretreatment method is not conducive to enzymolysis of the shrimp head protein and even decreases the degree of hydrolysis of the shrimp head protein.

### Embodiment 3 Analysis of the Flavor of Enzymatic Hydrolysates of Aquatic Proteins after DPCD Treatment

### I. Determination of the Taste of Enzymatic Hydrolysates

### (1) Determination Method

The enzymatic hydrolysates were diluted for 5 times after being filtered, and then placed in a 30 mL cup, respectively. The taste of the enzymatic hydrolysates was determined by using 8 sensors of an INSENTTS-5000Z electronic tongue to obtain response values of a sour taste, an astringent taste, a bitter taste, a fresh taste, a fresh aftertaste, a saline taste, an astringent aftertaste (aftertaste-A) and a bitter aftertaste (aftertaste-B). A determination procedure was maintenance measurement; a sample determination frequency was 4 times (the latter 3 times were used as results); a cleaning frequency was 2-steps-washing; and the sensors were Foodstuff. Wherein, a shorter distance between different sample data indicates a smaller difference between these samples; and a longer distance between different sample data indicates a greater difference between these samples.

### (2) Determination Results

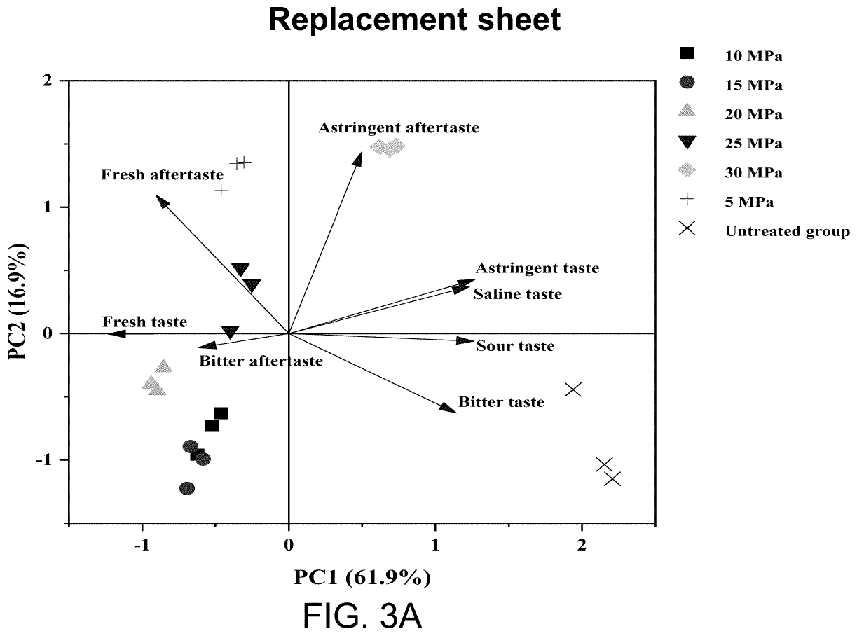

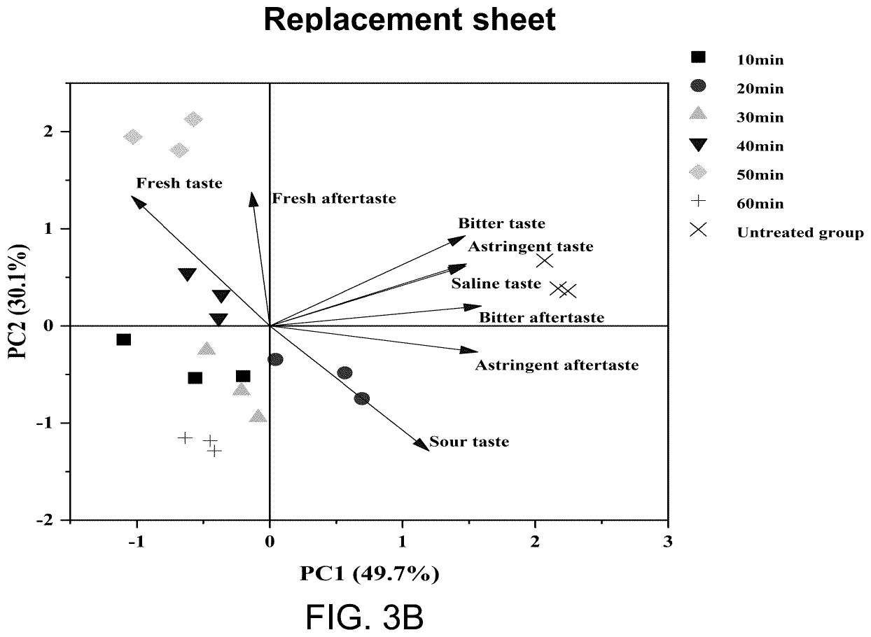

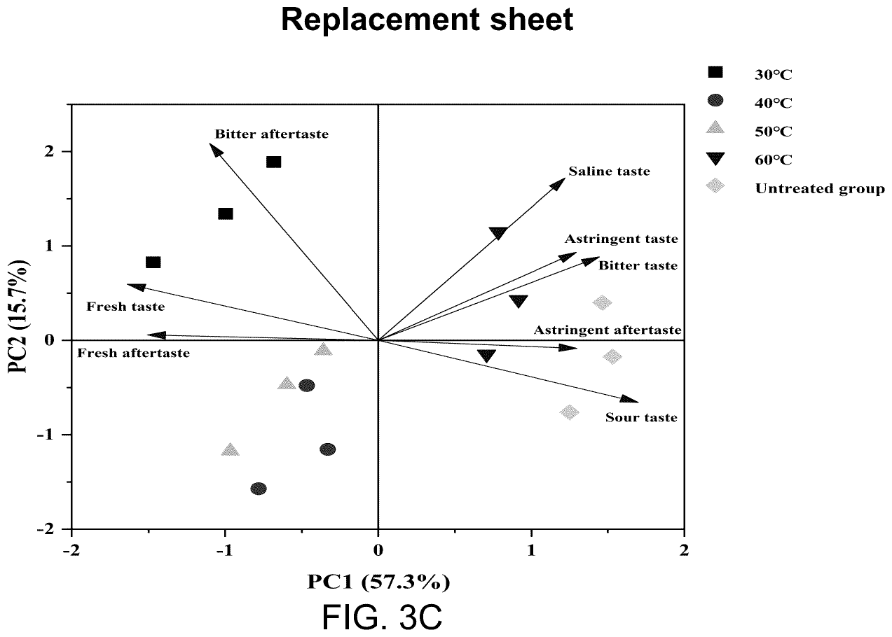

Principal component analysis (PCA) was performed on measured data. Results are shown in FIG. 3. Wherein, FIG. 3A shows determination results of the taste of enzymatic hydrolysates of proteins at different pressures of DPCD, FIG. 3B shows determination results of the taste of enzymatic hydrolysates of proteins at different time points of DPCD, and FIG. 3C shows determination results of the taste of enzymatic hydrolysates of proteins at different temperatures of DPCD.

As can be seen from FIG. 3, data points of the taste of the enzymatic hydrolysate of the shrimp head protein in the untreated group and data points of the taste of the enzymatic hydrolysates of the shrimp head proteins in the DPCD treatment groups are not in the same quadrant and have relatively long distances. It can be seen that when the shrimp head proteins are treated by DPCD and then subjected to enzymolysis, the taste of the enzymatic hydrolysates is remarkably different from that in the untreated group, in which good tastes such as a fresh taste and a fresh aftertaste are increased, and poor tastes such as a bitter taste, an astringent taste and a sour taste are remarkably decreased, indicating that the DPCD treatment can improve the taste of the enzymatic hydrolysates of the shrimp head proteins.

### II. Determination of the Smell of Enzymatic Hydrolysates

### (1) Determination Method

After 5 mL of the enzymatic hydrolysates were each placed in a 20 mL headspace vial and balanced in a water bath at 55° C. for 20 min, the smell of the enzymatic hydrolysates was determined by using a portable PEN3 electronic nose system. Each sample was determined in parallel for 3 times.

Before the sample was tested, a cleaning time of the electronic nose system was set at 70 s, and a sample determination time was set at 150 s. The electronic nose system consists of 10 metal oxide sensor systems and recognition software, and performance analysis of each different sensor is shown in Table 3.

TABLE 3
Performance analysis of PEN3 electronic nose sensors

| | | | Sensor corresponding |
|---|---|---|---|
| Serial | Sensor | Description of | group, detection |
| number | name | performance | limit (mL/m³) |
| R₁ | W1C | Sensitive to aromatics | C₇H₈, 10 |
| | | and benzene components | |
| R₂ | W5S | Sensitive to nitrogen oxides | NO₂, 1 |
| R₃ | W3C | Sensitive to amines and | C₆H₆, 10 |
| | | aromatic compounds | |
| R₄ | W6S | Mainly selective to hydrides | H₂, 100 |
| R₅ | W5C | Sensitive to alkanes and | C₃H₈, 1 |
| | | aromatic compounds | |
| R₆ | W1S | Mainly sensitive to | CH₄, 100 |
| | | methyl groups | |
| R₇ | W1W | Sensitive to inorganic | H₂S, 1 |
| | | sulfides and terpenes | |
| R₈ | W2S | Mainly sensitive to alcohols | CO, 100 |
| | | and aldehyde ketones | |
| R₉ | W2W | Sensitive to aromatic | H₂S, 1 |
| | | components and organic | |
| | | sulfides | |
| R₁₀ | W3S | Sensitive to long- | CH₄, 10 |
| | | chain alkanes | |

### (2) Determination Results

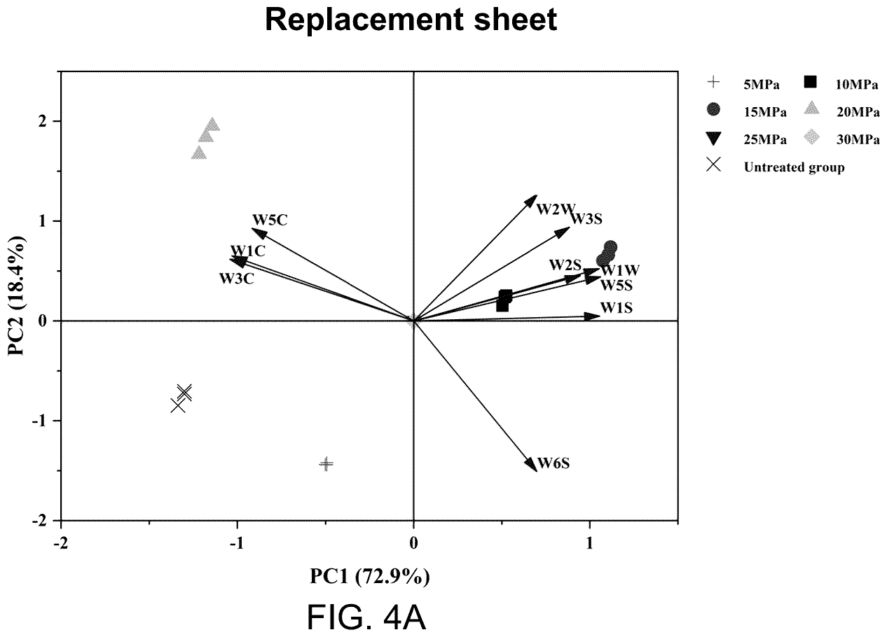

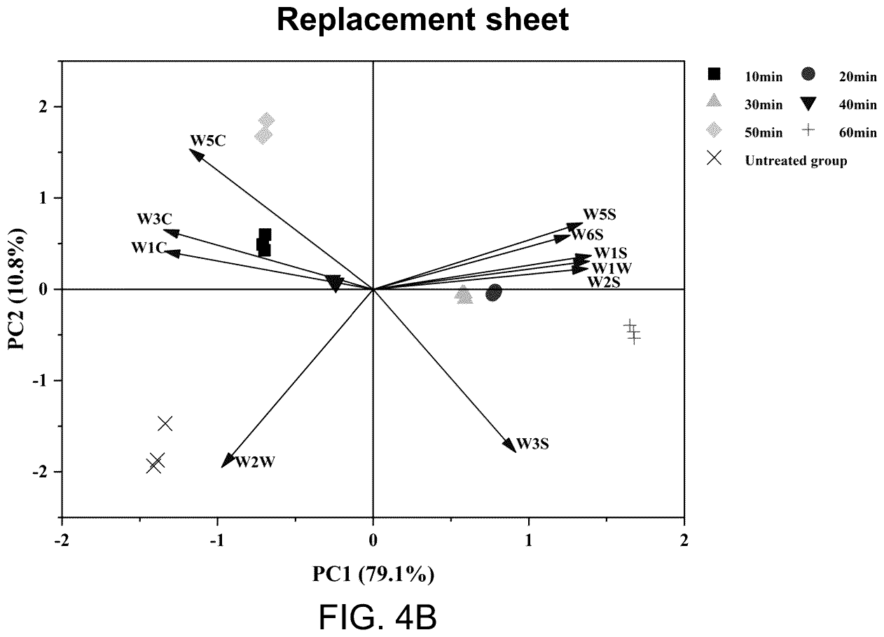

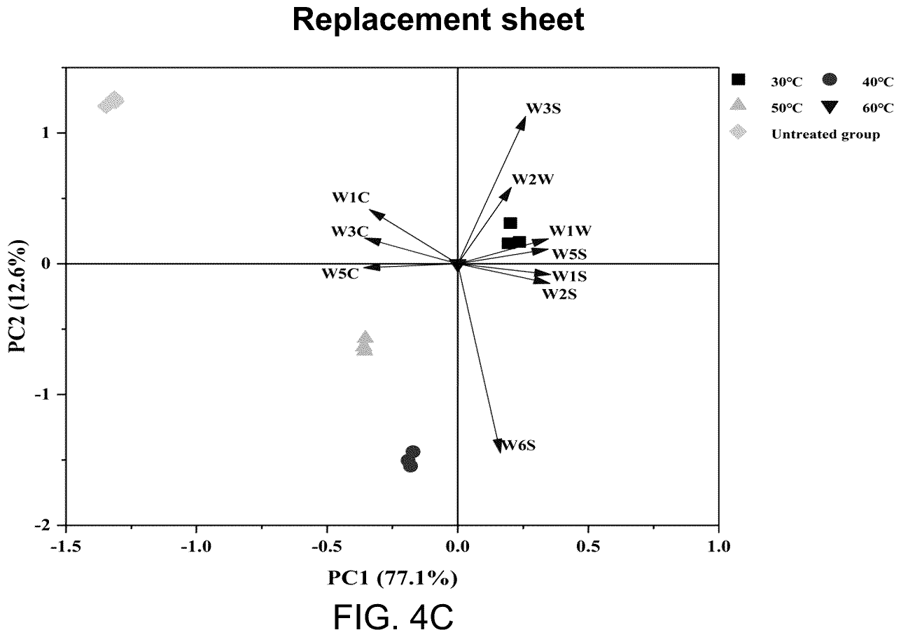

Determination results are shown in FIG. 4, wherein FIG. 4A shows determination results of the smell of enzymatic hydrolysates of proteins at different pressures of DPCD, FIG. 4B shows determination results of the smell of enzymatic hydrolysates of proteins at different time points of DPCD, and FIG. 4C shows determination results of the smell of enzymatic hydrolysates of proteins at different temperatures of DPCD.

As can be seen from FIG. 4, data points of the smell of the shrimp head protein in the untreated group and data points of the smell of the enzymatic hydrolysates of the shrimp head proteins in the DPCD treatment groups are not in the same quadrant and have relatively long distances. It can be seen that when the shrimp head proteins are treated by DPCD and then subjected to enzymolysis, the smell of the enzymatic hydrolysates is remarkably different from that in the untreated group, in which aromatic substances (compounds sensitive to WIC, W3C and W5C sensors) are remarkably increased, and odorous substances (compounds sensitive to WIS, W2S, W3S, W5S, W6S and W1W sensors) are remarkably decreased, indicating that the DPCD treatment can improve the smell of the enzymatic hydrolysates of the shrimp head proteins.

In summary, according to the present invention, by using the DPCD technology to pretreat the aquatic protein and specifically controlling the conditions (pressure, temperature, and time) of the technology, not only is the degree of hydrolysis of the aquatic protein treated by means of the DPCD technology remarkably increased, but also the flavor (taste and smell) of an enzymatic hydrolysate of the aquatic product is remarkably improved, and an utilization rate of protein resources is remarkably increased.

The above examples are preferred embodiments of the present invention, but the embodiments of the present invention are not limited to the above examples. Any other changes, modifications, substitutions, combinations and simplifications that are made without deviating from the spirit, essence and principles of the present invention shall be regarded as equivalent replacement modes, which shall be included in the scope of protection of the present invention.

1. A method for improving the flavor of an enzymatic hydrolysate of an aquatic protein, wherein the aquatic protein is pretreated by using a dense phase carbon dioxide technology, and conditions of the dense phase carbon dioxide technology are that: a pressure is 15-30 MPa, a temperature is 40-60° C., and a time is 20-60 min;
the improving the flavor of the enzymatic hydrolysate of the aquatic protein is one or several of increasing a fresh taste, increasing a fresh aftertaste, decreasing a bitter taste, decreasing an astringent taste, decreasing a sour taste and increasing aromatic substances.

2. (canceled)

3. The method according to claim 1, wherein the pressure is 20 MPa.

4. (canceled)

5. The method according to claim 1, wherein the temperature is 50° C.

6. (canceled)

7. The method according to claim 1, wherein the time is 30 min.

8. (canceled)

9. (canceled)

10. The method according to claim 1, wherein the aquatic protein comprises one or several of a fish protein, a shrimp protein, and a shellfish protein.

11. The method according to claim 3, wherein the aquatic protein comprises one or several of a fish protein, a shrimp protein, and a shellfish protein.

12. The method according to claim 5, wherein the aquatic protein comprises one or several of a fish protein, a shrimp protein, and a shellfish protein.

13. The method according to claim 7, wherein the aquatic protein comprises one or several of a fish protein, a shrimp protein, and a shellfish protein.
